(19) United States
(12) Patent Application Publication
(10) Pub. No.: US 2018/0187007 A1
(43) Pub. Date: Jul. 5, 2018

(54) Thermoplastic Resin Composition for Laser Direct Structuring Process and Composite Comprising the Same

(71) Applicant: Lotte Advanced Materials Co., Ltd., Yeosu-si (KR)

(72) Inventors: Jung Ki Kim, Uiwang-si (KR); Nam Hyun Kim, Uiwang-si (KR); Ik Mo Kim, Uiwang-si (KR); Jee Kwon Park, Uiwang-si (KR); Yoo Jin Jung, Uiwang-si (KR); Sang Hyun Hong, Uiwang-si (KR)

(21) Appl. No.: 15/856,114

(22) Filed: Dec. 28, 2017

(30) Foreign Application Priority Data
Dec. 30, 2016 (KR) 10-2016-0184492

(51) Int. Cl. C08L 69/00

(52) U.S. Cl. CPC C08L 69/00; C08L 2207/53; C08L 2205/03; C08L 2205/025; C08L 2205/22

(57) ABSTRACT

Disclosed herein is a thermoplastic resin composition for laser direct structuring. The thermoplastic resin composition includes: (A) about 60 wt % to about 75 wt % of a polycarbonate resin; (B) about 5 wt % to about 30 wt % of a continuous phase and dispersed phase-containing aromatic vinyl-diene-vinyl cyanide copolymer; (C) about 1 wt % to about 15 wt % of a core-shell type rubber-modified aromatic vinyl graft copolymer; and (D) about 1 wt % to about 10 wt % of an additive for laser direct structuring (LDS additive), wherein the thermoplastic resin composition has an R_{W} of higher than about 1 to about 6, as defined by Equation 1:

R_{W}=W_{B}/W_{C}
wherein W_{B} denotes a weight of the continuous phase and dispersed phase-containing aromatic vinyl-diene-vinyl cyanide copolymer (B), and W_{C} denotes a weight of the core-shell type rubber-modified aromatic vinyl graft copolymer (C).

### CROSS-REFERENCE TO RELATED APPLICATION

This application claims priority under 35 USC Section 119 to and the benefit of Korean Patent Application No. 10-2016-0184492, filed on Dec. 30, 2016 in the Korean Intellectual Property Office, the entire disclosure of which is incorporated herein by reference.

### FIELD

The present invention relates to a thermoplastic resin composition for laser direct structuring and a composite including the same.

### BACKGROUND

Laser direct structuring (LDS) may be employed to deposit a metal layer on at least a portion of a surface of a molded article formed of a thermoplastic resin composition. LDS is a process performed prior to plating, wherein a region of the surface of the molded article to be plated is irradiated with laser beams to modify the region such that the region can have suitable properties for plating. For this purpose, a thermoplastic resin composition used in manufacture of the molded article is required to include an additive for LDS, which can form metal nuclei upon irradiation with laser beams. Upon receiving laser beams, the additive is decomposed into metal nuclei. In addition, a surface of the molded article having been irradiated with laser beams becomes rougher. Due to presence of the metal nuclei and surface roughness, the laser beam-modified region can be suitable for plating.

LDS allows rapid and efficient formation of electric/electronic circuits on a three-dimensional shape of a molded article. For example, LDS can be utilized in manufacture of antennas for portable electronic devices, radio frequency identification (RFID) antennas, and the like.

Recently, with reduction in device weight and thickness, there is an increasing demand for a thermoplastic resin composition which can exhibit heat resistance and reliability while having good mechanical properties and moldability (appearance characteristics). In addition, as the thickness of a micro-pattern (plating region) of a portable electronic device and the like is reduced, a plating layer is more likely to be delaminated.

Therefore, there is a need for a thermoplastic resin composition for LDS, which can have good plating adhesion and mechanical properties with minimum or no deterioration in moldability and heat resistance.

### SUMMARY OF THE INVENTION

Embodiments of the present invention provide a thermoplastic resin composition for laser direct structuring (LDS), which can have good properties in term of heat resistance, impact resistance, discoloration resistance, and/or moldability.

Embodiments of the present invention provide a thermoplastic resin composition for laser direct structuring, which can have good LDS plating reliability and is suitable as a material for mobile device components.

The thermoplastic resin composition for LDS includes: (A) about 60 wt % to about 75 wt % of a polycarbonate resin; (B) about 5 wt % to about 30 wt % of a continuous phase and dispersed phase-containing aromatic vinyl-diene-vinyl cyanide copolymer; (C) about 1 wt % to about 15 wt % of a core-shell type rubber-modified aromatic vinyl graft copolymer; and (D) about 1 wt % to about 10 wt % of an additive for LDS (LDS additive), wherein the thermoplastic resin composition has an R_{W} of higher than about 1 to about 6, as defined by Equation 1:

R_{W}=W_{B}/W_{C}

(wherein W_{B} denotes a weight of the continuous phase and dispersed phase-containing aromatic vinyl-diene-vinyl cyanide copolymer (B), and W_{C} denotes a weight of the core-shell type rubber-modified aromatic vinyl graft copolymer (C)).

The thermoplastic resin composition may have an R_{W} of about 1.2 to about 6.

The continuous phase and dispersed phase-containing aromatic vinyl-diene-vinyl cyanide copolymer (B) may include a rubber polymer having a volume average particle diameter of about 0.7 μm to about 1.5 μm.

The continuous phase and dispersed phase-containing aromatic vinyl-diene-vinyl cyanide copolymer (B) may have a structure in which a dispersed phase including a diene polymer is dispersed in a continuous phase including an aromatic vinyl-vinyl cyanide copolymer.

The continuous phase and dispersed phase-containing aromatic vinyl-diene-vinyl cyanide copolymer (B) may be a copolymer comprising about 30 wt % to about 70 wt % of an aromatic vinyl compound, about 1 wt % to about 35 wt % of a diene polymer, and about 15 wt % to about 35 wt % of a vinyl cyanide compound.

The core-shell type rubber-modified aromatic vinyl graft copolymer (C) may have a volume average particle diameter of about 0.1 μm to about 1 μm.

The thermoplastic resin composition may have a bimodal rubber particle size distribution.

The LDS additive (D) may include at least one of a heavy metal composite oxide spinel and a copper salt.

A weight ratio of the continuous phase and dispersed phase-containing aromatic vinyl-diene-vinyl cyanide copolymer (B) to the LDS additive (D) may range from about 3:1 to about 6:1.

A weight ratio of the core-shell type rubber-modified aromatic vinyl graft copolymer (C) to the LDS additive (D) may range from about 1.3:1 to about 3:1.

The thermoplastic resin composition may satisfy Equation 2 and Equation 3:

50 cm≤Id≤80 cm [Equation 2]

(wherein Id denotes a height from which dropping a 2 kg weight results in breakage of a 2 mm thick specimen in a DuPont drop impact test),

115° C.≤VST≤150° C. [Equation 3]

(wherein VST denotes a Vicat softening temperature measured in accordance with ISO 306/B50).

Another embodiment of the present invention relates to a composite manufactured using the thermoplastic resin composition as set forth above. The composite includes: a resin layer formed of the thermoplastic resin composition; and a metal layer formed on at least one surface of the resin layer.

The resin layer may have a structure in which the core-shell type rubber-modified aromatic vinyl graft copolymer, the diene polymer, and the LDS additive are dispersed in a continuous phase including the polycarbonate resin and the aromatic vinyl-vinyl cyanide copolymer.

The resin layer may have a bimodal rubber particle size distribution.

The metal layer may be formed by plating after completion of laser direct structuring.

The present invention provides a thermoplastic resin composition for LDS, which can have good properties in term of heat resistance, impact resistance, discoloration resistance, moldability, and/or LDS plating reliability and is suitable as a material for mobile device components.

### BRIEF DESCRIPTION OF DRAWINGS

FIG. 1 is a schematic sectional view of a composite according to one embodiment of the present invention.

### DETAILED DESCRIPTION OF THE INVENTION

The above and other aspects, features, and advantages of the present invention will become apparent from the detailed description of the following embodiments in conjunction with the accompanying drawings. It should be understood that the present invention is not limited to the following embodiments and may be embodied in different ways by those skilled in the art without departing from the scope of the present invention. Rather, the embodiments are provided for complete disclosure and to provide thorough understanding of the present invention by those skilled in the art. The scope of the present invention should be defined only by the appended claims.

Hereinafter, embodiments of the present invention will be described in detail.

(A) Polycarbonate Resin

According to the present invention, the polycarbonate resin may include any typical polycarbonate resin used in thermoplastic resin compositions for LDS. For example, the polycarbonate resin may be an aromatic polycarbonate resin prepared by reacting one or more diphenols (aromatic diol compounds) with a carbonate precursor such as phosgene, halogen formate, and/or carbonate diester.

Examples of the diphenols may include 4,4′-biphenol, 2,2-bis(4-hydroxyphenyl)-propane, 2,4-bis(4-hydroxyphenyl)-2-methylbutane, 1,1-bis(4-hydroxyphenyl)cyclohexane, 2,2-bis(3-chloro-4-hydroxyphenyl)propane, 2,2-bis-(3,5-dichloro-4-hydroxyphenyl)propane, 2,2-bis(3-methyl-4-hydroxyphenyl)propane, and 2,2-bis(3,5-dimethyl-4-hydroxyphenyl)propane, without being limited thereto. These may be used alone or as a mixture thereof. For example, the diphenols may be 2,2-bis-(4-hydroxyphenyl)propane, 2,2-bis(3,5-dichloro-4-hydroxyphenyl)propane, 2,2-bis(3-methyl-4-hydroxyphenyl)propane, 2,2-bis(3,5-dimethyl-4-hydroxyphenyl)propane, and/or 1,1-bis(4-hydroxyphenyl)cyclohexane, for example 2,2-bis-(4-hydroxyphenyl)propane, which is also referred to as bisphenol A.

Examples of the carbonate precursor may include without limitation dimethyl carbonate, diethyl carbonate, dibutyl carbonate, dicyclohexyl carbonate, diphenyl carbonate, ditolyl carbonate, bis(chlorophenyl) carbonate, m-cresyl carbonate, dinaphthyl carbonate, carbonyl chloride (phosgene), diphosgene, triphosgene, carbonyl bromide, and bishaloformate. These may be used alone or as a mixture thereof.

The polycarbonate resin may be a branched polycarbonate resin. For example, the polycarbonate resin may be prepared by adding a tri- or higher polyfunctional compound, for example, a tri- or higher valent phenol group-containing compound, in an amount of 0.05 mol % to 2 mol % based on the total number of moles of the diphenols used in polymerization.

The polycarbonate resin may be a homopolycarbonate resin, a copolycarbonate resin, or a blend thereof. In addition, the polycarbonate resin may be partly or completely replaced by an aromatic polyester-carbonate resin obtained by polymerization in the presence of an ester precursor, for example, a bifunctional carboxylic acid.

In some embodiments, the polycarbonate resin may have a weight average molecular weight (Mw) of 10,000 g/mol to 200,000 g/mol, for example, 15,000 g/mol to 40,000 g/mol, as measured by gel permeation chromatography (GPC). Within this range, the thermoplastic resin composition for LDS can have good properties in terms of impact resistance, rigidity, and/or heat resistance.

In some embodiments, the polycarbonate resin may be present in an amount of about 60 wt % to about 75 wt % based on the total weight (100 wt %) of the thermoplastic resin composition for LDS. If the amount of the polycarbonate resin is outside this range, the thermoplastic resin composition can have poor properties in terms of impact resistance, heat resistance, plating adhesion, appearance, surface hardness, and/or moldability. In some embodiments, the thermoplastic resin composition may include the polycarbonate resin in an amount of about 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, or 75 wt %. Further, according to some embodiments of the present invention, the polycarbonate resin may be present in an amount of from about any of the foregoing amounts to about any other of the foregoing amounts.

(B) Continuous Phase and Dispersed Phase-Containing Aromatic Vinyl-Diene-Vinyl Cyanide Copolymer

According to the present invention, the aromatic vinyl-diene-vinyl cyanide copolymer (B) has a structure in which a dispersed phase including a diene polymer is dispersed in a continuous phase including an aromatic vinyl-vinyl cyanide copolymer.

In some embodiments, the aromatic vinyl-diene-vinyl cyanide copolymer may be prepared by mass polymerization, solution polymerization, emulsion polymerization or the like.

The aromatic vinyl-diene-vinyl cyanide copolymer may be a copolymer of about 30 wt % to about 70 wt % of the aromatic vinyl compound, about 1 wt % to about 35 wt % of the diene polymer, and about 15 wt % to about 35 wt % of the vinyl cyanide compound, based on 100 wt % of the aromatic vinyl-diene-vinyl cyanide copolymer. When the aromatic vinyl-diene-vinyl cyanide copolymer has the aforementioned composition, the aromatic vinyl-diene-vinyl cyanide copolymer can have good compatibility with the polycarbonate resin and thus can improve impact resistance of the thermoplastic resin composition.

In some embodiments, the aromatic vinyl-diene-vinyl cyanide copolymer may include the aromatic vinyl compound in an amount of about 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, or 70 wt %. Further, according to some embodiments of the present invention, the aromatic vinyl compound may be present in an amount of from about any of the foregoing amounts to about any other of the foregoing amounts.

In some embodiments, the aromatic vinyl-diene-vinyl cyanide copolymer may include the diene polymer in an amount of about 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, or 35 wt %. Further, according to some embodiments of the present invention, the diene polymer may be present in an amount of from about any of the foregoing amounts to about any other of the foregoing amounts.

In some embodiments, the aromatic vinyl-diene-vinyl cyanide copolymer may include the vinyl cyanide compound in an amount of about 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, or 35 wt %. Further, according to some embodiments of the present invention, the vinyl cyanide compound may be present in an amount of from about any of the foregoing amounts to about any other of the foregoing amounts.

In some embodiments, the aromatic vinyl-diene-vinyl cyanide copolymer may include a rubber polymer having a volume average particle diameter of about 0.7 μm to about 1.5 μm. Within this range of volume average particle diameter, the thermoplastic resin composition can have good properties in terms of moldability and/or impact resistance.

In some embodiments, the aromatic vinyl-diene-vinyl cyanide copolymer may have a melt-flow index of about 6.5 g/10 min to about 10 g/10 min, as measured at 220° C. under a load of 10 kg in accordance with ISO 1133. Within this range of melt-flow index, the thermoplastic resin composition can have good moldability.

In some embodiments, the continuous phase and dispersed phase-containing aromatic vinyl-diene-vinyl cyanide copolymer may be present in an amount of about 5 wt % to about 30 wt %, for example about 10 wt % to about 25 wt %, based on the total weight (100 wt %) of the thermoplastic resin composition. In some embodiments, the thermoplastic resin composition may include the continuous phase and dispersed phase-containing aromatic vinyl-diene-vinyl cyanide copolymer in an amount of about 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, or 30 wt % in the thermoplastic resin composition. Further, according to some embodiments of the present invention, the continuous phase and dispersed phase-containing aromatic vinyl-diene-vinyl cyanide copolymer may be present in an amount of from about any of the foregoing amounts to about any other of the foregoing amounts.

If the amount of the continuous phase and dispersed phase-containing aromatic vinyl-diene-vinyl cyanide copolymer is less than about 5 wt %, the thermoplastic resin composition can have poor properties in term of plating reliability and/or moldability, whereas, if the amount of the continuous phase and dispersed phase-containing aromatic vinyl-diene-vinyl cyanide copolymer exceeds about 30 wt %, the thermoplastic resin composition can have poor properties in term of impact resistance, heat resistance, and/or moldability.

(C) Rubber-Modified Aromatic Vinyl Graft Copolymer

According to the present invention, the rubber-modified aromatic vinyl graft copolymer has a core-shell structure in which an aromatic vinyl monomer and a monomer copolymerizable with the aromatic vinyl monomer are grafted to a rubber polymer.

In some embodiments, the rubber-modified aromatic vinyl graft copolymer may be prepared by adding the aromatic vinyl monomer and the monomer copolymerizable with the aromatic vinyl monomer to the rubber polymer, followed by polymerization. Here, the polymerization may include any suitable polymerization method known in the art, such as emulsion polymerization, suspension polymerization, and mass polymerization.

Examples of the rubber polymer may include without limitation diene rubbers such as polybutadiene, poly(styrene-butadiene), and poly(acrylonitrile-butadiene); saturated rubbers obtained by adding hydrogen to the diene rubbers; isoprene rubbers; acrylic rubbers such as polybutyl acrylate; and an ethylene-propylene-diene monomer terpolymer (EPDM). These may be used alone or as a mixture thereof. For example, the rubber polymer may be a diene rubber, for example a butadiene rubber.

In some embodiments, the rubber polymer may be present in an amount of about 5 wt % to about 65 wt %, for example about 10 wt % to about 60 wt %, and as another example about 20 wt % to about 50 wt %, based on the total weight (100 wt %) of the rubber-modified aromatic vinyl graft copolymer. In some embodiments, the rubber-modified aromatic vinyl graft copolymer may include the rubber polymer in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, or 65 wt %. Further, according to some embodiments of the present invention, the rubber polymer may be present in an amount of from about any of the foregoing amounts to about any other of the foregoing amounts.

Within this range, the thermoplastic resin composition can have good impact resistance and/or mechanical properties.

In addition, the rubber polymer (rubber particles) may have an average (volume average) particle size of about 0.1 μm to about 1 μm, for example about 0.15 μm to about 0.5 μm, and as another example about 0.20 μm to about 0.35 μm. Within this range, the thermoplastic resin composition can have good properties in terms of impact resistance and/or appearance.

The aromatic vinyl monomer is graft-copolymerizable with the rubber copolymer and may include, for example, styrene, α-methylstyrene, β-methylstyrene, p-methylstyrene, p-t-butyl styrene, ethyl styrene, vinylxylene, monochlorostyrene, dichlorostyrene, dibromostyrene, and vinyl naphthalene, without being limited thereto. These may be used alone or as a mixture thereof.

In some embodiments, the aromatic vinyl monomer may be present in an amount of about 15 wt % to about 94 wt %, for example about 20 wt % to about 80 wt %, and as another example about 30 wt % to about 60 wt %, based on the total weight (100 wt %) of the rubber-modified aromatic vinyl graft copolymer. In some embodiments, the rubber-modified aromatic vinyl graft copolymer may include the aromatic vinyl monomer in an amount of about 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, or 94 wt %. Further, according to some embodiments of the present invention, the aromatic vinyl monomer may be present in an amount of from about any of the foregoing amounts to about any other of the foregoing amounts.

Within this range, the thermoplastic resin composition can have good impact resistance and/or mechanical properties.

Examples of the monomer copolymerizable with the aromatic vinyl monomer may include without limitation vinyl cyanide compounds such as acrylonitrile, methacrylonitrile, ethacrylonitrile, phenylacrylonitrile, α-chloroacrylonitrile, and fumaronitrile, (meth)acrylic acids and/or alkyl esters thereof, maleic anhydride, and N-substituted maleimide. These may be used alone or as a mixture thereof. As used herein, unless otherwise defined, the term “alkyl” refers to C1 to C10 alkyl. In exemplary embodiments, the monomer copolymerizable with the aromatic vinyl monomer may be acrylonitrile, methyl (meth)acrylate, or a combination thereof.

The monomer copolymerizable with the aromatic vinyl monomer may be present in an amount of about 1 wt % to about 50 wt %, for example about 5 wt % to about 45 wt %, and as another example about 10 wt % to about 30 wt %, based on the total weight (100 wt %) of the rubber-modified aromatic vinyl graft copolymer. In some embodiments, the rubber-modified aromatic vinyl graft copolymer may include the monomer copolymerizable with the aromatic vinyl monomer in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the monomer copolymerizable with the aromatic vinyl monomer may be present in an amount of from about any of the foregoing amounts to about any other of the foregoing amounts.

Within this range, the thermoplastic resin composition can have good properties in terms of impact resistance, flowability, and/or appearance.

Examples of the rubber-modified aromatic vinyl graft copolymer may include an acrylonitrile-butadiene-styrene graft copolymer (g-ABS) in which a styrene monomer as the aromatic vinyl compound and an acrylonitrile monomer as the vinyl cyanide compound are grafted to a butadiene rubber and/or a methyl methacrylate-butadiene-styrene graft copolymer (g-MBS) in which a styrene monomer as the aromatic vinyl compound and methyl methacrylate as the monomer copolymerizable with the aromatic vinyl compound are grafted to a butadiene rubber, without being limited thereto.

In some embodiments, the rubber-modified aromatic vinyl graft copolymer may be present in an amount of about 1 wt % to about 15 wt % based on the total weight (100 wt %) of the thermoplastic resin composition. In some embodiments, the thermoplastic resin composition may include the rubber-modified aromatic vinyl graft copolymer in an amount of about 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, or 15 wt % based on the total weight of the thermoplastic resin composition. Further, according to some embodiments of the present invention, the rubber-modified aromatic vinyl graft copolymer may be present in an amount of from about any of the foregoing amounts to about any other of the foregoing amounts.

If the amount of the rubber-modified aromatic vinyl graft copolymer is less than about 1 wt %, the thermoplastic resin composition can have poor impact resistance. If the amount of the rubber-modified aromatic vinyl graft copolymer exceeds about 15 wt %, the thermoplastic resin composition can suffer from deterioration in plating reliability and/or discoloration resistance.

In some embodiments, the thermoplastic resin composition may have an R_{W} of higher than 1 to about 6, as defined by Equation 1:

R_{W}=W_{B}/W_{C}

wherein W_{B} denotes a weight of the continuous phase and dispersed phase-containing aromatic vinyl-diene-vinyl cyanide copolymer (B), and W_{C} denotes a weight of the core-shell type rubber-modified aromatic vinyl graft copolymer (C).

If R_{W} is less than or equal to about 1, the thermoplastic resin composition can have poor properties in term of plating reliability and moldability and suffer from discoloration. If R_{W} exceeds about 6, the thermoplastic resin composition can have poor impact resistance. In exemplary embodiments, the thermoplastic resin composition may have an R_{W} of about 1.2 to about 6. For example, the thermoplastic resin composition may have an R_{W} of about 2, 3, 4, 5, or 6.

Since the continuous phase and dispersed phase-containing aromatic vinyl-diene-vinyl cyanide copolymer (B) and the core-shell type rubber-modified aromatic vinyl graft copolymer (C) both include a rubber polymer, the thermoplastic resin composition according to the present invention may have a bimodal rubber particle size distribution. The thermoplastic resin composition having a bimodal rubber particle size distribution can have further improved impact resistance.

(D) LDS Additive

According to the present invention, the LDS additive serves to form metal nuclei upon irradiation with laser beams and may include any typical LDS additive used in resin compositions for LDS.

The LDS additive may include a heavy metal composite oxide spinel and/or a copper salt.

The heavy metal composite oxide spinel may be represented by Formula 2:

AB₂O₄

wherein A is a metal cation having a valence of 2, for example, magnesium, copper, cobalt, zinc, tin, iron, manganese, nickel, and a combination thereof, and B is a metal cation having a valence of 3, for example, manganese, nickel, copper, cobalt, tin, titanium, iron, aluminum, chromium, and a combination thereof.

Examples of the LDS additive may include without limitation copper-iron spinel, magnesium-aluminum oxides, copper-chromium-manganese oxides, copper-manganese-iron oxides (oxygen may be optionally bonded to the aforementioned compounds), salts and/or oxides of copper, for example, cupric oxide, cuprous oxide, copper phosphate, copper sulfate, and/or cuprous thiocyanate, metal complexes (coordination complexes whose center atom is a metal atom), chelates of copper, tin, nickel, cobalt, silver and/or palladium, copper-chromium oxide, zinc-iron oxide, cobalt-chromium oxide, cobalt-aluminum oxide, magnesium-aluminum oxide, and mixtures thereof; surface-treated products thereof; and/or oxygen-bonded products thereof. For example, the LDS additive may include copper hydroxide phosphate, copper-chromium oxide spinel, copper phosphate, copper sulfate, cuprous thiocyanate, and/or a combination thereof.

In some embodiments, the LDS additive may be present in an amount of about 1 wt % to about 10 wt % based on the total weight (100 wt %) of the thermoplastic resin composition for LDS. In some embodiments, the thermoplastic resin composition may include the LDS additive in an amount of about 1 wt %, 2 wt %, 3 wt %, 4 wt %, 5 wt %, 6 wt %, 7 wt %, 8 wt %, 9 wt %, or 10 wt % in the thermoplastic resin composition for LDS. Further, according to some embodiments of the present invention, the LDS additive may be present in an amount of from about any of the foregoing amounts to about any other of the foregoing amounts. Within this range, the thermoplastic resin composition for LDS can have good properties in terms of plating adhesion, modulus, surface hardness, and/or appearance.

In some embodiments, a weight ratio of the continuous phase and dispersed phase-containing aromatic vinyl-diene-vinyl cyanide copolymer (B) to the LDS additive (D) may range from about 3:1 to about 6:1. In some embodiments, the weight ratio of the continuous phase and dispersed phase-containing aromatic vinyl-diene-vinyl cyanide copolymer (B) to the LDS additive (D) may be about 3:1, 4:1, 5:1, or 6:1. Within this range, the thermoplastic resin composition for LDS can have further improved plating adhesion.

In addition, a weight ratio of the core-shell type rubber-modified aromatic vinyl graft copolymer (C) to the LDS additive (D) may range from about 1.3:1 to about 3:1. In some embodiments, the weight ratio of the core-shell type rubber-modified aromatic vinyl graft copolymer (C) to the LDS additive (D) may be about 1.3:1, 1.4:1, 1.5:1, 1.6:1, 1.7:1, 1.8:1, 1.9:1, 2:1, 2.1:1, 2.2:1, 2.3:1, 2.4:1, 2.5:1, 2.6:1, 2.7:1, 2.8:1, 2.9:1 or 3:1. Within this range, the thermoplastic resin composition for LDS can have further improved impact resistance.

In some embodiments, the thermoplastic resin composition may further include any typical additive commonly used in thermoplastic resin compositions for LDS without altering the effects of the present invention, as needed. Examples of the additive may include lubricants, colorants, stabilizers, antioxidants, antistatic agents, and/or flow enhancers, without being limited thereto. When the thermoplastic resin composition includes the additive, the additive may be present in an amount of about 0.01 wt % to about 20 wt % based on the total weight (100 wt %) of the thermoplastic resin composition.

In some embodiments, the thermoplastic resin composition may be prepared in pellet form by mixing the aforementioned components, followed by melt extrusion using a typical twin-screw extruder at about 200° C. to about 300° C., for example, about 250° C. to about 280° C.

In some embodiments, the thermoplastic resin composition for LDS may satisfy Equation 2 and Equation 3:

50 cm≤Id≤80 cm [Equation 2]

wherein Id denotes a height from which dropping a 2 kg weight results in breakage of a 2 mm thick specimen in a DuPont drop impact test,

115° C.≤VST≤150° C. [Equation 3]

wherein VST denotes a Vicat softening temperature measured in accordance with ISO 306/B50.

In accordance with another embodiment of the present invention, a molded article is formed of the thermoplastic resin composition for LDS as set forth above. For example, the molded article may be prepared by any suitable molding method, such as injection molding, double injection molding, blowing, extruding, and thermoforming, using the thermoplastic resin composition. The molded article can be easily formed by a person having ordinary skill in the art to which the present invention pertains.

In accordance with a further embodiment of the present invention, a composite includes the thermoplastic resin composition for LDS as set forth above.

In some embodiments, the composite includes a resin layer formed of the thermoplastic resin composition; and a metal layer formed on at least one surface of the resin layer.

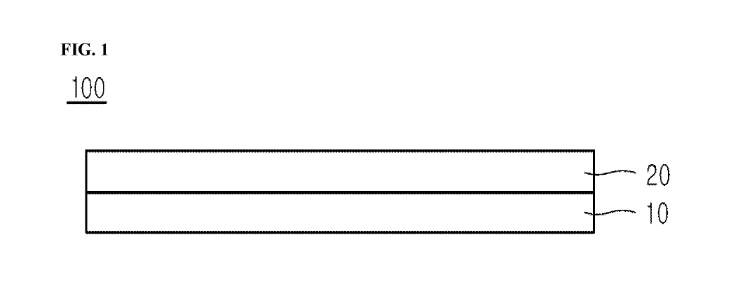

FIG. 1 is a schematic sectional view of a composite 100 according to one embodiment of the present invention. It should be noted that the drawing is exaggerated in thickness of lines or size of components for descriptive convenience and clarity only. Referring to FIG. 1, the composite 100 includes a resin layer 10 and a metal layer 20 formed on at least one surface of the resin layer. Here, the metal layer 20 may be formed by plating after completion of laser direct structuring.

The composite may be prepared by fabricating a molded article through injection molding or the like using the thermoplastic resin composition for LDS; and irradiating a specific region of a surface of the molded article with laser beams, followed by metallization (plating) of the irradiated region to form the metal layer.

The resin layer may have a structure in which the core-shell type rubber-modified aromatic vinyl graft copolymer, the diene polymer, and the LDS additive are dispersed in a continuous phase including the polycarbonate resin and the aromatic vinyl-vinyl cyanide copolymer.

The resin layer may have a bimodal rubber particle size distribution.

In some embodiments, the LDS additive included in the thermoplastic resin composition for LDS is decomposed to form metal nuclei upon irradiation with laser beams. In addition, the laser beam-irradiated region has a suitable surface roughness for plating. Here, the laser beams can have a wavelength of about 248 nm, about 308 nm, about 355 nm, about 532 nm, about 1,064 nm, and/or about 10,600 nm.

In some embodiments, the metallization may be performed by any typical plating process. For example, the metallization may include dipping the laser beam-irradiated molded article in at least one electroless plating bath to form the metal layer (electrically conductive path) on the laser beam-irradiated region of the surface of the molded article. Here, examples of the electroless plating bath may include a copper plating bath, a gold plating bath, a nickel plating bath, a silver plating bath, a zinc plating bath, and/or a tin plating bath.

Next, the present invention will be described in more detail with reference to the following examples. It should be understood that these examples are provided for illustration only and are not to be in any way construed as limiting the present invention.

### EXAMPLE

Details of components used in Examples and Comparative Examples are as follows:

(A) Polycarbonate resin: L-1225WX (Teijin Chemical Ltd.)

(B) Continuous phase and dispersed phase-containing aromatic vinyl-diene-vinyl cyanide copolymer: ER400 (LG Chemical Co., Ltd.)

(C) Core-shell type rubber-modified aromatic vinyl graft copolymer: A g-ABS copolymer (Lotte Advanced Material Co., Ltd.)

(D) LDS additive: Iriotec 884X (Merck Chemicals Ltd.)

### Examples 1 to 5 and Comparative Examples 1 to 6

The aforementioned components are mixed in amounts as listed in Tables 1 and 2, followed by melt extrusion under conditions of a barrel temperature of 250° C. to 300° C., a screw rotation speed of 250 rpm, and a self-supply rate of 25 rpm using a twin-screw extruder (L/D=36, ϕ 45 mm), thereby preparing a thermoplastic resin composition for LDS in pellet form. The pellets are dried at 100° C. for 4 hours or more, followed by injection molding, thereby preparing a specimen. The prepared specimen is subjected to aging for 24 hours and then evaluated as to the following properties. Results are shown in Table 1.

Property Evaluation

(1) Plating reliability: Each of the specimens prepared in Examples and Comparative Examples is plated over an area of 3 cm×3 cm, followed by aging in a thermo-hygrostat chamber (85° C./85% relative humidity (RH)) for 72 hours, and then a square grid (cell size: 1 mm×1 mm) is imprinted on the plated layer. Then, a 3M tape is attached to the plated layer, followed by detachment of the tape to check whether the plated layer is peeled off of the specimen.

A specimen not allowing the plated layer to be peeled off is rated as “good”, whereas a specimen allowing the plated layer to be peeled off is rated as “bad”

(2) Discoloration: Each of the specimens is left in a thermo-hygrostat chamber (85° C./85% RH) for a predetermined period of time, followed by observation of discoloration of each specimen with the naked eye. A specimen causing no discoloration is rated as “good”, whereas a specimen causing discoloration is rated as “bad”.

(3) Surface impact strength (cm): In accordance with the DuPont drop impact test, a height from which dropping a 2 kg weight resulted in breakage of a 2 mm thick specimen is measured.

(4) Vicat softening temperature (VST, ° C.): Vicat softening temperature is measured in accordance with ISO 306/B50.

(5) Moldability: Whether short shot/flash occurs in preparation of a 1 mm thick specimen through injection molding at 270° C. is observed. A specimen causing no short shot/flash is rated as “good”, whereas a specimen causing short shot/flash is rated as “bad”.

TABLE 1

| | Example | | | | |
|---|---|---|---|---|---|
| Unit (wt %) | 1 | 2 | 3 | 4 | 5 |
| (A) PC | 65 | 66 | 67 | 65 | 67 |
| (B) c-ABS | 20 | 23 | 16 | 23 | 24 |
| (C) g-ABS | 10 | 4 | 12 | 7 | 4 |
| (D) LDS additive | 5 | 5 | 5 | 5 | 5 |
| R_{W} | 2.0 | 5.8 | 1.3 | 3.3 | 6 |
| Plating reliability | Good | Good | Good | Good | Good |
| Discoloration | Good | Good | Good | Good | Good |
| Surface impact | 65 | 60 | 70 | 68 | 58 |
| strength (cm) | | | | | |
| (50 cm or more) | | | | | |
| VST (° C.) | 126 | 125 | 125 | 124 | 125 |
| (115° C. or more) | | | | | |
| Moldability | Good | Good | Good | Good | Good |

TABLE 2

| | Comparative Example | | | | | |
|---|---|---|---|---|---|---|
| Unit (wt %) | 1 | 2 | 3 | 4 | 5 | 6 |
| (A) PC | 68 | 80 | 65 | 55 | 65 | 65 |
| (B) c-ABS | 25 | 5 | 10 | 30 | 15 | 26 |
| (C) g-ABS | 2 | 10 | 20 | 10 | 15 | 4 |
| (D) LDS additive | 5 | 5 | 5 | 5 | 5 | 5 |
| R_{W} | 12.5 | 0.5 | 0.5 | 3.0 | 1 | 6.5 |
| Plating reliability | Good | Bad | Bad | Good | Bad | Good |
| Discoloration | Good | Good | Bad | Good | Bad | Good |
| Surface impact | 28 | 70 | 70 | 31 | 66 | 46 |
| strength (cm) | | | | | | |
| (50 cm or more) | | | | | | |
| VST (° C.) | 126 | 133 | 126 | 91 | 122 | 124 |
| (115° C. or more) | | | | | | |
| Moldability | Good | Bad | Good | Bad (flash) | Good | Bad |

From the results shown in Table 1, it can be seen that the thermoplastic resin composition for LDS has good properties in terms of heat resistance, impact resistance, LDS plating reliability, discoloration resistance, and moldability. Conversely, the thermoplastic resin compositions of Comparative Examples 1 and 6 having an R_{W} above the range specified in the present invention have poor surface impact strength, and the thermoplastic resin compositions of Comparative Examples 2 and 3 having an R_{W} below the range specified in the present invention have poor properties in terms of plating reliability, discoloration resistance, and moldability. In addition, the thermoplastic resin composition of Comparative Example 4 using the polycarbonate in an amount below the range specified in the present invention has poor surface impact strength, heat stability, and moldability. Further, the thermoplastic resin composition of Comparative Example 5 having an R_{W} of 1 has poor properties in terms of plating reliability and discoloration resistance.

Exemplary embodiments have been disclosed herein, and although specific terms are employed, they are to be interpreted in a generic and descriptive sense only and not for purpose of limitation. Also although some embodiments have been described above, it should be understood that these embodiments are provided for illustration only and are not to be construed in any way as limiting the present invention, and that various modifications, changes, alterations, and equivalent embodiments can be made by those skilled in the art without departing from the spirit and scope of the invention. The scope of the present invention should be defined by the appended claims and equivalents thereof.

What is claimed is:

1. A thermoplastic resin composition for laser direct structuring (LDS), comprising:
(A) about 60 wt % to about 75 wt % of a polycarbonate resin;
(B) about 5 wt % to about 30 wt % of a continuous phase and dispersed phase-containing aromatic vinyl-diene-vinyl cyanide copolymer;
(C) about 1 wt % to about 15 wt % of a core-shell type rubber-modified aromatic vinyl graft copolymer; and
(D) about 1 wt % to about 10 wt % of an additive for laser direct structuring (LDS additive),
wherein the thermoplastic resin composition has an R_{W} of higher than about 1 to about 6, as defined by Equation 1:
R_{W}=W_{B}/W_{C}
wherein W_{B} denotes a weight of the continuous phase and dispersed phase-containing aromatic vinyl-diene-vinyl cyanide copolymer (B), and W_{C} denotes a weight of the core-shell type rubber-modified aromatic vinyl graft copolymer (C).

2. The thermoplastic resin composition according to claim 1, wherein the thermoplastic resin composition has an R_{W} of about 1.2 to about 6.

3. The thermoplastic resin composition according to claim 1, wherein the continuous phase and dispersed phase-containing aromatic vinyl-diene-vinyl cyanide copolymer (B) comprises a rubber polymer having a volume average particle diameter of about 0.7 μm to about 1.5 μm.

4. The thermoplastic resin composition according to claim 1, wherein the continuous phase and dispersed phase-containing aromatic vinyl-diene-vinyl cyanide copolymer (B) has a structure in which a dispersed phase comprising a diene polymer is dispersed in a continuous phase comprising an aromatic vinyl-vinyl cyanide copolymer.

5. The thermoplastic resin composition according to claim 1, wherein the continuous phase and dispersed phase-containing aromatic vinyl-diene-vinyl cyanide copolymer (B) is a copolymer comprising about 30 wt % to about 70 wt % of an aromatic vinyl compound, about 1 wt % to about 35 wt % of a diene polymer, and about 15 wt % to about 35 wt % of a vinyl cyanide compound.

6. The thermoplastic resin composition according to claim 1, wherein the core-shell type rubber-modified aromatic vinyl graft copolymer (C) has a volume average particle diameter of about 0.1 μm to about 1 μm.

7. The thermoplastic resin composition according to claim 1, wherein the thermoplastic resin composition has a bimodal rubber particle size distribution.

8. The thermoplastic resin composition according to claim 1, wherein the LDS additive (D) comprises at least one of a heavy metal composite oxide spinel and a copper salt.

9. The thermoplastic resin composition according to claim 1, wherein a weight ratio of the continuous phase and dispersed phase-containing aromatic vinyl-diene-vinyl cyanide copolymer (B) to the LDS additive (D) ranges from about 3:1 to about 6:1.

10. The thermoplastic resin composition according to claim 1, wherein a weight ratio of the core-shell type rubber-modified aromatic vinyl graft copolymer (C) to the LDS additive (D) ranges from about 1.3:1 to about 3:1.

11. The thermoplastic resin composition according to claim 1, wherein the thermoplastic resin composition satisfies Equation 2 and Equation 3:
50 cm≤Id≤80 cm [Equation 2]
wherein Id denotes a height from which dropping a 2 kg weight results in breakage of a 2 mm thick specimen in a DuPont drop impact test,
115° C.≤VST≤150° C. [Equation 3]
wherein VST denotes a Vicat softening temperature measured in accordance with ISO 306/B50.

12. A composite comprising:
a resin layer formed of the thermoplastic resin composition according to claim 1; and
a metal layer formed on at least one surface of the resin layer.

13. The composite according to claim 12, wherein the resin layer has a structure in which the core-shell type rubber-modified aromatic vinyl graft copolymer, the diene polymer, and the LDS additive are dispersed in a continuous phase comprising the polycarbonate resin and the aromatic vinyl-vinyl cyanide copolymer.

14. The composite according to claim 12, wherein the resin layer has a bimodal rubber particle size distribution.

15. The composite according to claim 12, wherein the metal layer is formed by plating after completion of laser direct structuring.
